(19) United States
(12) Patent Application Publication
(10) Pub. No.: US 2007/0287497 A1
(43) Pub. Date: Dec. 13, 2007

(54) Computer compressed myopia eyeglasses lens

(76) Inventor: Ray Worthington Douglas, Big Creek, KY (US)

Correspondence Address: RAY WORTHINGTON DOUGLAS, P.O. Box 186, BIG CREEK, KY, 40914, US

(21) Appl. No.: 11/633,596

(22) Filed: Jun. 9, 2006

(51) Int. Cl. H04M 1/00

(52) U.S. Cl. 455/556.1

(57) ABSTRACT

Interactive eye glasses comprising a bluetooth design frame, housing two peripheral lenses and a wrist watch that acts as a cell phone. The left and right lens is coupled to the frame. The control circuitry of the wrist watch is electronically coupled to the eye glasses frame, also the digital display screen outputs alpha-numeric characters. The left support hinge, of the frame, acts as a cell phone receiver. The right support hinge acts as a television remote control device, to increase or decrease volume for televisions. The power means is made possible by a bLB-3 battery inside the wrist watch.

### BACKGROUND OF THE INVENTION

1. Field of the Invention

The modern day invention relates to a specific, more comprehensive as far as sight use, lens.

2. Background Art

The use of the eye glasses, options of variety either in the form of nearsighted or farsighted or sunglasses or bifocal or trifocal users, etc., the uses of all styles adaptable to this particular new lens. Such eye glasses generally have a frame and style of lens associated with the frame. Certain embodiments, new modifications have been made to this particular lens.

Such eye glasses, in typical fashion mentioned above, are common. This lens has never been made known or used in the public arena. Moreover, nano technology configured in a (i.e., peripheral concavoconvex lens), self energy supply known, classification bLB-3 battery. In general eye glasses are commonly not configured in this manner.

It is an object of the invention to to overcome the prior art, of earlier submissions of design.

Objective, a eyeglasses frame with lens, frame acts as telephone, and television remote.

Intention to object of the invention making conventional even more conventional a a pair of eye glasses with a peripheral lens.

These and objects of the invention appended with specification and claims.

### SUMMARY OF THE INVENTION

The invention introduces an interactive pair of eye glasses including a interactive frame; two lenses, a telephone/cell phone receiver; a television volume control remote control device, all activated by a wrist watch. All belonging to the eye glasses frame. All interactive execution, activation of use, comprises a wrist watch serving as a cell phone and is coupled to the eye glasses frame. The wrist watch works in partnership with the eye glasses frame. Nano technology along with bluetooth capability makes all this possible. A hands-free function, when the user speaks, answers the phone, the eye glasses frame acts as telephone receiver. The wrist watch has a display screen displaying digital numbers, when person is placing a call, digital numbers appear, identifying the telephone number that is being dialed. The control circuitry is electronically designed to hook up to satellite communication. Virtually, the person placing the call can wear the eye glasses and wrist watch any place on earth and the telephone call will be placed.

In a preferred embodiment, both lenses in frame are concavoconvex in a peripheral manner. The lens refracts the diverging wave fronts proceeding from objects. The lens is designed to attract the proper prism light to make the peripheral eye sight more comfortable for user.

In another preferred embodiment, the left lens support hinge, acts as a telephone/cell phone receiver. There is nano technology circuitry in receiver.

In another embodiment, the television remote is in the right lens support hinge. This device, through a bluetooth process, makes it possible for the wrist watch along with the eyeglasses frame to increase or decrease volume for any given television console.

The circuitry comprises an input and output electronic communication that is electronically safe for any other electronic device in the activation area of the eye glasses.

In one such embodiment, a nano RF converter is located inside the watch connecting to the right eye glasses hinge that makes sound volume control possible for the user for any given television.

A 3.6 volt battery is located inside the wrist watch powering the telephone and volume control for televisions. Style and description of battery: a BLB-3 battery located inside the wrist watch.

In another embodiment the display screen of the wrist watch displays alpha-numeric characters.

In one embodiment the optic refraction formula for the computer compressed myopia eye glasses lens is [ [symbol] concav(us)+−0−+CONVEX] The diverging wave fronts are concavoconvex, concave on one side and convex on the other.

In an aspect of the embodiment associating a peripheral lens to a universal cell phone in association with satellite hook up.

### BRIEF DESCRIPTION OF THE DRAWINGS

The invention described as follows with reference to the drawings wherein:

FIG. 1 of the drawings comprises a view of an embodiment of the invention;

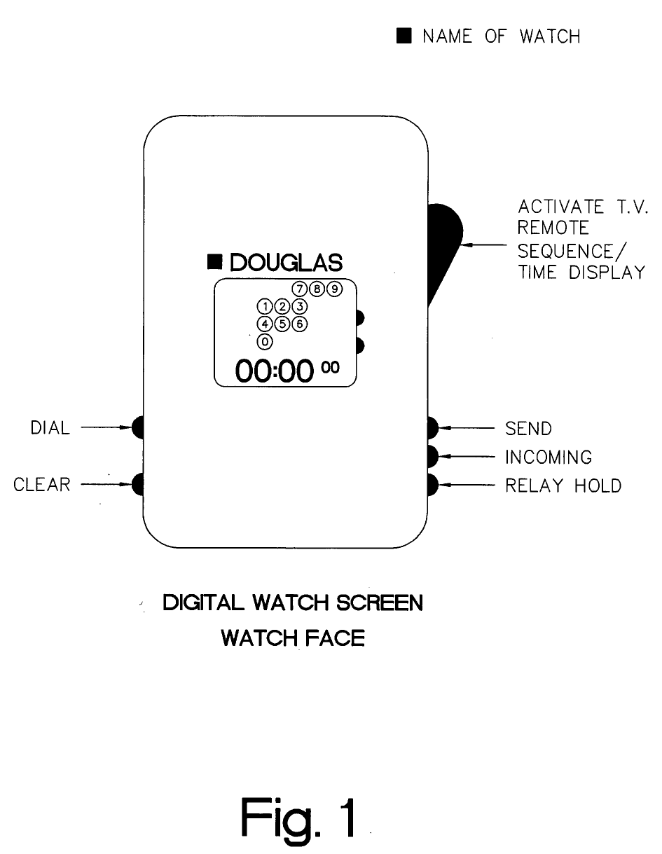

FIG. 2 of the drawings shows a front plan view of the invention, showing in particular the left and right hinges of the eye glasses. The left hinge shows the telephone receiver built into the hinge. The right hinge shows the television volume control built into the right hinge.

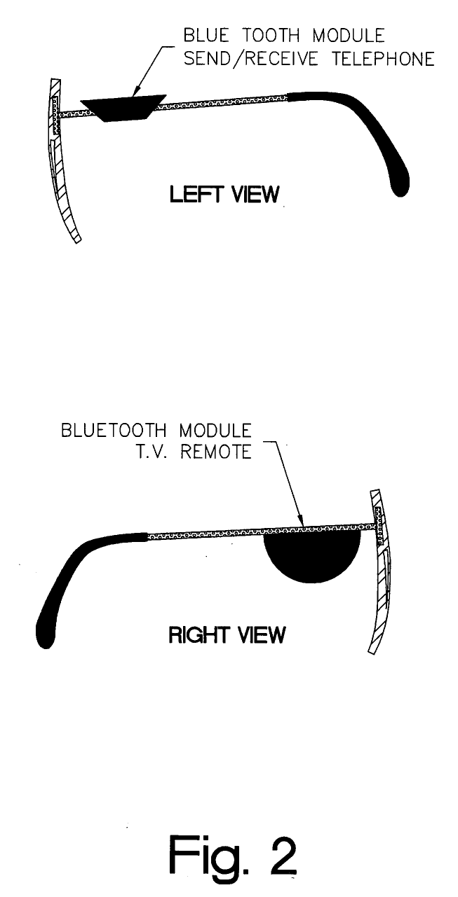

FIG. 3 of the drawings comprises a perspective view of an embodiment of the invention, showing, the wrist watch with wrist band, comprising a view of alpha-numeric characters of the watches digital screen.

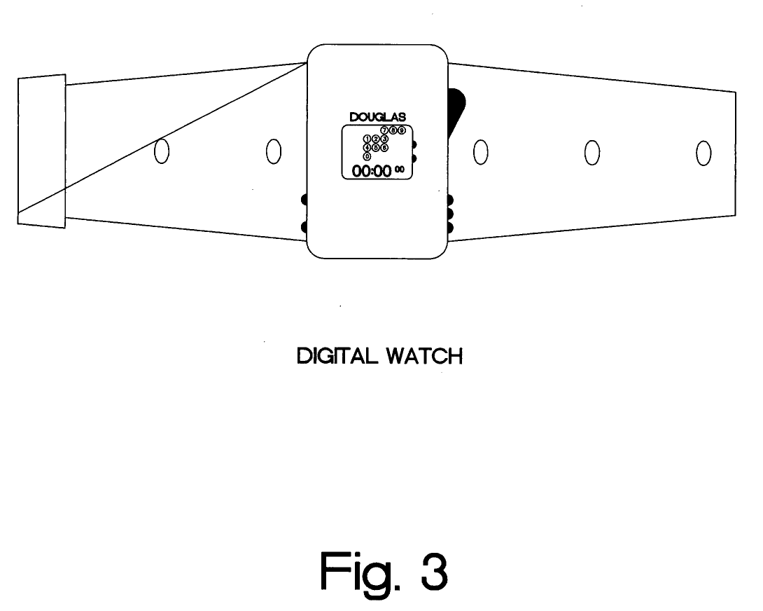

FIG. 4 shows a belt clip. This is an option feature. A user can clip the wrist watch to an optional belt clip if desired.

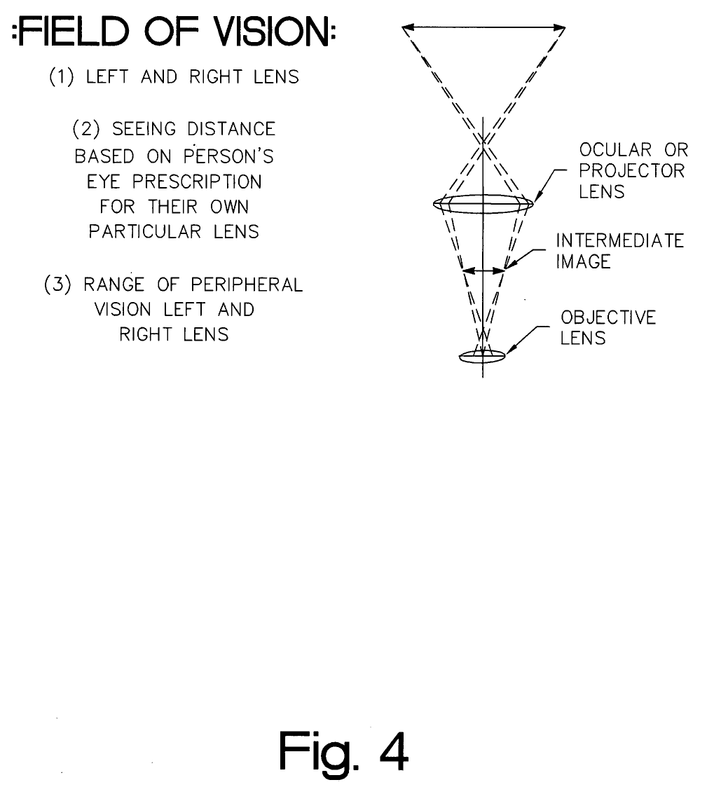

FIG. 5 of the drawings comprises a view of the lens surface measurements. Lines A, B, C, and D represent measurements of peripheral splice, meaning the peripheral placement in lens.

### DETAILED DESCRIPTION OF THE INVENTION

It will be understood that the eye glasses may be comprised of any of the following styles (i.e., bifocals, trifocals, monofocals, or any other style, also sunglasses). The new lens will suffice and work in any design just mentioned.

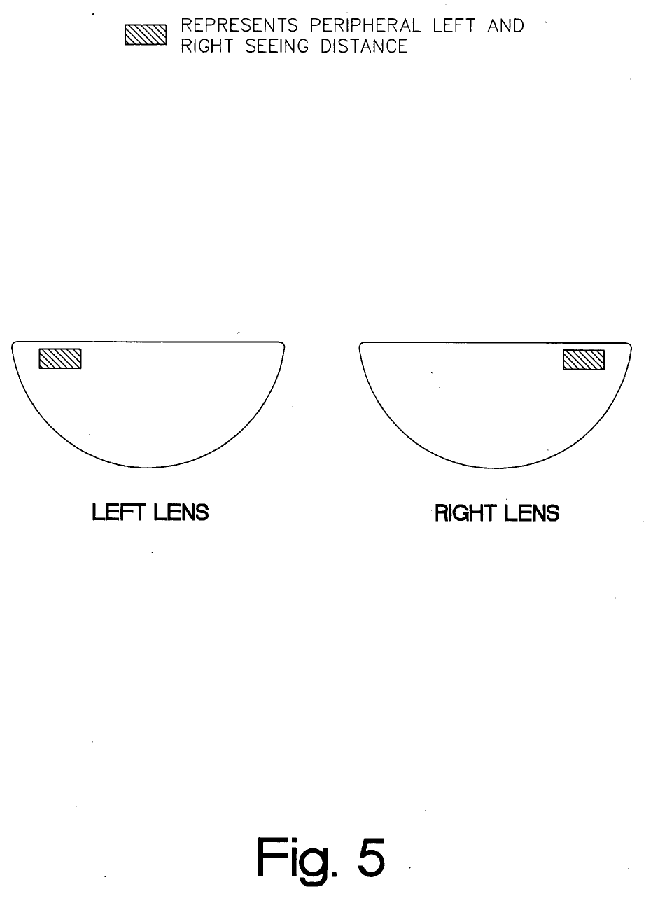

In FIG. 5 as comprising lens surface, the following measurements apply; Line A to C represent the lens total width measurement.

Line A to B is where the total peripheral part of the lens takes place.

The Line A to C, the total lens width is 2 inches and ⅛ in measurement. The Line A to B, the total peripheral section of the lens width is ¼ inches and Four Sixteenths.

In relation to, in another embodiment, the eye glasses frame has a left and right hinge support coupled to the control circuitry of the Nano Technology inside the electronic sections of the hinges.

The input and the output of the electronic sections of the hinges is initiated by a BLB-3 battery, a 3.6 volt battery.

The BLB-3 battery is located inside the wrist watch.

In one such embodiment the wrist watch includes a Bluetooth communication coupled to a RF converter port. This makes the television volume control, (t.v. remote control feature) in the control circuitry of the right eye glasses hinge, activate any television to increase or decrease the television's volume.

The left eye glasses hinge, acts as a cell phone/telephone receiver. A Bluetooth communication coupled to cell phone components, making the eye glasses interactive. A communication between the wrist watch and the eye glasses frame that include the electronic hinges.

Audibles from incoming callers are received in the wrist watch and the user that wears the eye glasses can hear the incoming callers voice by listening to the wrist watch. This is a Bluetooth communication.

In one such embodiment, the wrist watch also includes a plurality of buttons. The buttons have alpha-numeric characters. The user will press the proper button that represents the number desired. The function is the same as most cell phones. Caller places the call.

The interactive eye glasses wrist watch, also has a digital display screen prompting user there is an incoming call. There is an audible tone that the wrist watch makes, the user hears the tone and answers phone by pressing the (answer) button on wrist watch.

What is claimed is:

1. Interactive eye glasses comprising and consisting of:
a frame having:
2 lenses, both peripheral in nature;
a cell phone receiver in left support hinge;
a volume control for televisions in right support hinge;
a digital display screen identifying incoming telephone calls. Location, wrist watch;
electronic circuitry created by bluetooth technology, coupled to the digital display screen. Location of screen is on the wrist watch surface.
a plurality of buttons activating bluetooth technology to place and receive telephone calls. Location of buttons on wrist watch. The buttons have alpha-numeric characters.

2. The interactive eye glasses of claim 1 wherein:
the lens is a new style of lens acting as a peripheral lens in a bluetooth technology device.
audibles spoken by user by a hands-free method. Audibles collected immediately by left support hinge.
The hinge is a cell phone receiver. This is made possible by bluetooth technology.

3. The interactive eye glasses of claim 1 wherein the volume control (television remote control function) takes place and is positioned in the right support hinge of eye glasses frame. Also made possible by bluetooth technology.
an input and output RF converter port;
electronically coupled to wrist watch.
RF frequency activated by wrist watch.
the eye glasses frame communicates with the wrist watch through Nano Technology.

4. The interactive eye glasses of claim 1 wherein the wrist watch has digital alpha-numeric characters on the watches digital display screen.

5. The interactive eye glasses of claim 1 wherein the plurality of buttons on the watches digital display screen activates the users call by dialing the number when buttons are pushed.
